(19) United States
(12) Patent Application Publication
(10) Pub. No.: US 2020/0156729 A1
(43) Pub. Date: May 21, 2020

(54) MODULAR HANDLE GRIPS

(71) Applicant: Thomas William Marquis, Boulder, CO (US)

(72) Inventor: Thomas William Marquis, Boulder, CO (US)

(21) Appl. No.: 16/690,404

(22) Filed: Nov. 21, 2019

Related U.S. Application Data
(60) Provisional application No. 62/770,549, filed on Nov. 21, 2018.

(51) Int. Cl. B62K 21/26

(52) U.S. Cl. CPC B62K 21/26

(57) ABSTRACT

A handle grip system includes a compressible sleeve, a first collar, a second collar and several grip segments. The compressible sleeve has a length between a first end and a second end and a cooperative outer surface. The first collar is configured to surround the first end of the compressible sleeve and compress the compressible sleeve around a handlebar. The second collar is configured to surround the second end of the compressible sleeve and compress the compressible sleeve onto the handlebar. The grip segments each having an interior opening configured to receive the compressible sleeve therethrough such that the cooperative outer surface couples with a cooperative inner surface of the interior opening.

### CROSS REFERENCE TO RELATED APPLICATIONS

This application claims the priority benefit of U.S. Provisional Application No. 62/770,549 filed on Nov. 21, 2018, pending, which is incorporated herein by reference in its entirety.

### TECHNICAL FIELD

The disclosure relates to handles and facilitated gripping thereof.

### SUMMARY

The disclosure describes a handlebar grip system. The handlebar grip system includes a clamping sleeve, a first pipe clamp, a second pipe clamp and several grip segments. The clamping sleeve has a length between a first end and a second end and includes a first slot extending between the first end and the second end as well as several elongate teeth spaced around a perimeter of the clamping sleeve and extending between the first end and the second end thereof. The first pipe clamp is configured to surround the first end of the clamping sleeve and compress the clamping sleeve to reduce the first slot. The second pipe clamp is configured to surround the second end of the clamping sleeve and compress the clamping sleeve to reduce the first slot. The grip segments each have an interior opening configured to receive the clamping sleeve therethrough such that the elongate teeth mate with an inner wall of the interior opening.

Further, the disclosure describes a handle grip system including a compressible sleeve, a first collar, a second collar and several grip segments. The compressible sleeve has a length between a first end and a second end and a cooperative outer surface. The first collar is configured to surround the first end of the compressible sleeve and compress the compressible sleeve around a handlebar. The second collar is configured to surround the second end of the compressible sleeve and compress the compressible sleeve onto the handlebar. The grip segments each have an interior opening configured to receive the compressible sleeve therethrough such that the cooperative outer surface couples with a cooperative inner surface of the interior opening.

Still further, the disclosure describes a handlebar grip. The handlebar grip includes a clamping sleeve, a first clamp, a second clamp and several grip segments between the first clamp and the second clamp. The clamping sleeve has a length between a first end and a second end and includes a first slot extending between the first end and the second end and several ribs around a perimeter of the clamping sleeve and also extending between the first end and the second end thereof. The first clamp surrounds the first end of the clamping sleeve and reduces the first slot to compress the clamping sleeve around a handlebar. The second clamp surrounds the second end of the clamping sleeve and reduces the first slot to compress the clamping sleeve around a handlebar. Each of the grip segments has an interior opening receiving the clamping sleeve therethrough such that the ribs mate with an inner surface of the interior opening.

### BRIEF DESCRIPTION OF THE FIGURES

The summary above, as well as the following detailed description of illustrative embodiments, is better understood when read in conjunction with the appended drawings. For the purpose of illustrating the disclosure, example constructions of the disclosure are shown in the drawings. However, the disclosure is not limited to specific methods and instrumentalities disclosed herein. Moreover, those of ordinary skill in the art will understand that the drawings are not to scale. Wherever possible, like elements have been indicated by identical numbers.

Embodiments of the disclosure will now be described, by way of example only, with reference to the following diagrams wherein:

FIG. 1 illustrates an exploded view of an example handle grip system.

FIG. 2 illustrates an example handle grip system with excess grip segments in addition to those installed.

FIG. 3 illustrates a perspective view of an example handlebar grip.

FIG. 4 illustrates a sectional view of the example handlebar grip of FIG. 3.

FIG. 5 illustrates a comparison of perspective views of different configurations of the handle grip system.

FIG. 6 illustrates a comparison of perspective views of the handle grip in different states of flexion.

FIG. 7 illustrates an exploded view of another example handle grip system.

### DETAILED DESCRIPTION

The following detailed description illustrates embodiments of the disclosure and manners by which they can be implemented. Although the best mode of carrying out the disclosure has been disclosed, those of ordinary skill in the art would recognize that other embodiments for carrying out or practicing the disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Current bicycle handlebar grips are typically a one-hand size fits all solution for gripping a handlebar. A rider's hands shape and size vary significantly from one person to the next. Finding a grip that matches a rider's hand and personal style is difficult.

Handle grip systems according to the disclosure provide a modular system of segmented shapes having different sizes, shapes, densities, colors and textures enabling a customizable grip. Segments are chosen and then stacked onto an extruded shaft to form a grip shape that matches a riders hand size, comfort and style preferences.

Additional aspects, advantages, features and objects of the disclosure will be made apparent from the drawings and the detailed description of the illustrative embodiments construed in conjunction with the appended claims that follow.

It will be appreciated that features of the disclosure are susceptible to being combined in various combinations without departing from the scope of the disclosure as defined by the appended claims.

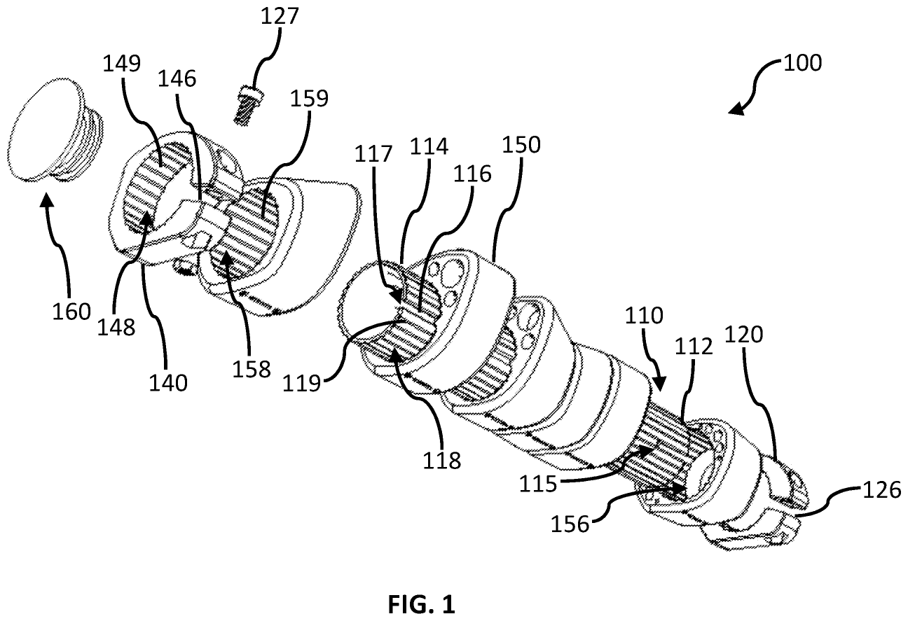

Referring to FIGS. 1 & 2, handle grip system 100 includes a compressible sleeve 110 in the form of a clamping sleeve or rail shaft, a first collar or clamp 120, a second collar or clamp 140 and several grip or shape segments 150.

Compressible sleeve 110 has a length between a first end 112 and a second end 114 and includes a first slot 116 extending between the first and second ends 112 and 114 as well as a cooperative outer surface 118. First slot 116 may be interrupted between the first end of the compressible sleeve and the second end of the compressible sleeve so as to yield a first notch 115 extending between the first end and the second end and a second notch 117 extending between the second end and the first end.

First collar 120 is configured to surround first end 112 of compressible sleeve 110 and selectively contribute to reduction of first slot 116 to compress compressible sleeve 110 around a handlebar. Second collar 140 is similarly configured to surround second end 114 of compressible sleeve 110 and selectively contribute to reduction of first slot 116 to compress compressible sleeve 110 around a handlebar. The amount by which first slot 116 is reduced by first and second collars 120 and 140 will depend on a variety of factors including the diameter of a handlebar onto which the system is installed relative to the diameter of compressible sleeve 110, beginning width of slot 116 and materials of construction for compressible sleeve 110. In an example, in practice, the width of slot 116 is not reduced to zero. In that sense, slot 116 is not closed first and second collars 120 and 140.

Compressible sleeve 110 may be constructed from any of a variety of durable materials having sufficient flexibility to enable varying width of slot 116 including metals, plastics or a combination of these. In an example, compressible sleeve 110 is formed from a material having a shape memory enabling compressible sleeve 110 to be programmed with a starting width of slot 116 to which it will return after a force being applied to reduce slot 116 is removed.

Grip segments 150 each have an interior opening 156 configured to receive compressible sleeve 110 therethrough such that cooperative outer surface 118 of compressible sleeve 110 mates with an inner surface 158 of interior opening 156.

Each of grip segments 150 may be configured to receive the compressible shaft at any of a variety of rotations about a longitudinal axis of the compressible shaft. The available rotations being limited only by the cooperative outer surface and the cooperative inner surface and their possible cooperative configurations.

Grip segments 150 may further include grip segments of a number of cross-sectional shapes, a number of colors, a number of textures, a number of patterns, a number of widths, a number of materials or a combination of these. In an example, grip segments 150 may be formed from rubbers or foams of varying density and/or hardness or a combination thereof. In a further example, indicia may be provided to an outer surface of grip segments 150 to identify characteristics of the individual segment or a guide assembly of a suitable series of segments.

Cooperative outer surface 118 may further include elongate ribs, teeth or splines 119 spaced around a perimeter of compressible sleeve 110 and extending between the first end and the second end thereof. Outer surface 118 and cooperative inner surface 158 of interior openings 156 of grip segments 150 are configured to prevent relative rotation about the longitudinal axis between any of the grip segments and the compressible sleeve when system 100 is installed in place on a handlebar. Cooperative inner surface 158 of grip segments 150 may take a form dependent on the form being used for compressible sleeve outer surface 118 so that they will be compatible. For example inner surface 158 may further include a number of splines 159 for interacting and/or cooperating with splines 119.

First and second collars 120 and 140 may further include inner walls with the cooperative inner surface 148. The type of the cooperative inner surface will depend on the type being used for compressible sleeve 110 and/or grip segments 150 so that they will be compatible. For example, cooperative inner surface 148 may further include a ribs, teeth or splines 149 configured to engage, respectively, ribs, teeth or splines 119 of compressible sleeve 110. First and second collars 120 and 140 may include a C-shape or an annular shape with a gap 126/146. The gap 126/146 is configured to be reduced by threaded fastener such as a bolt or set screw 127.

First and second collars 120 and 140 may be constructed from any of a variety of durable materials having sufficient flexibility to enable varying width of gaps 126/146 including metals, plastics or a combination of these. In an example, first and second collars 120 and 140 formed from a material having a shape memory enabling first and second collars 120 and 140 to be programmed with a starting width of gaps 126/124 to which they will return after a force being applied to reduce slot gaps 126/124 is removed (for example, bolt 127). First and second collars 120 and 140 may be identical, may be mirror images of one another or may be entirely different shapes depending on suitability for a given handlebar or vehicle.

First collar 120 and/or the second collar 140 may further include a side wall configured to seal one of the first and second ends of compressible sleeve 110. The side wall may further include an end plug 160 configured for receipt within one of first and second collars 120 and 140 and/or one of first 112 and second 114 ends of compressible sleeve 110. The side wall or end plug 160 may prevent foreign objects from entering a handlebar tube.

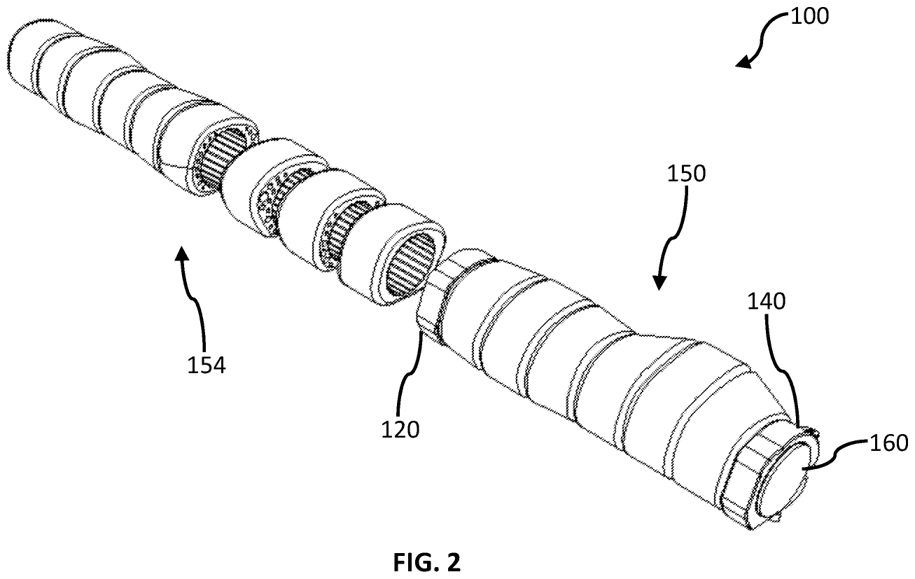

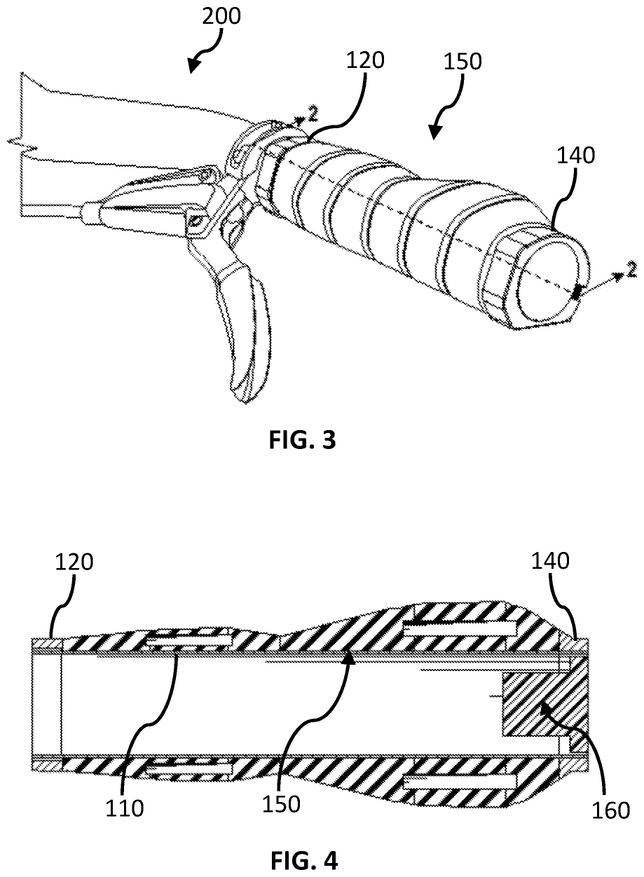

Referring to FIG. 2, each of grip segments 150 has a width and the sum of the widths of the grip segments is greater than the length of compressible sleeve 110 since there will be excess segments in addition to a quantity sufficient to span compressible sleeve 110 between the first and second collars 120 and 140. In an example, six grip segments may be sufficient to span the compressible sleeve while handle grip system 100 may be provided with thirty-six grip segments. In this example, the sum of the widths of all grip segments is greater than the length of the compressible sleeve by a factor of six. With thirty-six unique grip segments, 1.4×10⁶ unique, six-member subsets may be formed. In practice, some grip segments may be duplicated such that the number of unique subsets is less than this. The number of unique subsets/configurations possible will depend on the variety of grip segments provided with a handle grip system. Each unique subset of grip segments represents a different grip profile.

A method for applying or installing a handle grip system includes providing a compressible sleeve, a first collar, a second collar and several grip segments.

The compressible sleeve has a length between a first end and a second end and includes a first slot extending between the first end and the second end and a cooperative outer surface.

The first collar is configured to surround the first end of the compressible sleeve and compress the compressible sleeve onto a handlebar. The second collar is configured to surround the second end of the compressible sleeve and compress the compressible sleeve onto the handlebar.

The grip segments each have an interior opening configured to receive the compressible sleeve therethrough such that the cooperative outer surface couples with a cooperative inner surface of the interior opening.

The first collar is placed onto a handlebar spaced from a free end thereof and the compressible sleeve is placed onto the handlebar with the slot aligned with the handlebar length and the cooperative outer surface at least partly engaging an inner cooperative surface of the first collar. In some instances, it may be preferred to place the compressible sleeve onto the handlebar first and then slide the first collar into position over/along the compressible sleeve.

The method continues with sliding each of the several grip segments onto the compressible sleeve at a chosen rotation about the longitudinal axis relative to each other and the compressible sleeve. Grip segments are selected from a larger grouping according to a desired grip configuration, shape, texture, color or hardness and the length of handlebar available. A relative rotation between adjacent grip segments having a symmetry about the longitudinal axis will not generally be observable by a user. However, adjacent grip segments with a varied cross-sectional shape may be placed at any of a variety of relative rotations about the longitudinal axis. Cooperative surfaces between the grip segments and the compressible sleeve may constrain relative rotations to discrete measurements. In an example, relative rotations may be offset in 13-degree increments allowing for about twenty-seven different rotations.

Next, the second collar is slid onto the compressible sleeve so as to sandwich the grip segments between the first and second collars. The first collar is then clamped onto the compressible sleeve first end by tightening a bolt to reduce a gap of the first collar and the first slot of the compressible sleeve such that the compressible sleeve is clamped or cinched around the handlebar. Note, in some instances, it may be desirable to clamp first collar onto the compressible sleeve first end before sliding the grip segments or the second collar onto the compressible sleeve.

The second collar is clamped onto the compressible sleeve second end by tightening a bolt to reduce a gap of the second collar and the first slot of the compressible sleeve such that the compressible sleeve is clamped around the handlebar.

The actions described above are only illustrative and other alternatives can also be provided where one or more steps are added, one or more steps are removed, or one or more steps are provided in a different sequence without departing from the scope of the claims herein.

Actions described above install a handle grip system to provide a handlebar grip on a vehicle such as, for example, a bicycle, tricycle, motorcycle or scooter. The first and second clamps surround the first and second ends of the compressible sleeve and reduce the first slot compressing the compressible sleeve around a handlebar. The interior openings of each of the grip segments held between the first clamp and the second clamp surround the compressible sleeve with ribs around the perimeter of the compressible sleeve mating with ribs of the inner surface of the interior openings.

In addition to clamping the first and second clamps around the compressible sleeve, the bolts maintain the first and second clamps and the compressible sleeve in position on the handlebar.

Cooperation between the ribs of the compressible sleeve and an inner surface of the first and second clamps prevents relative rotation between the first clamp, the second clamp and the compressible sleeve.

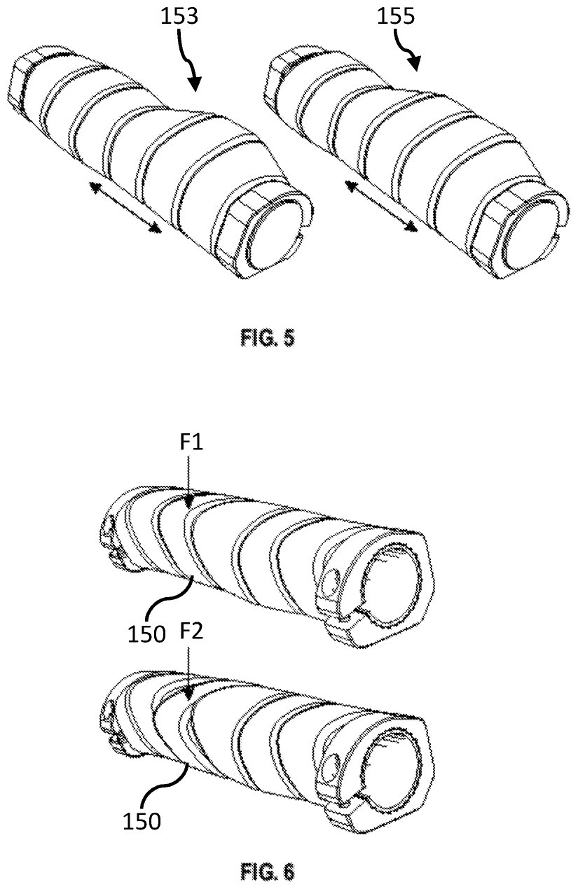

Again, a variety of grip configurations may result from the grip segment selection action. Referring to FIG. 5, a first configuration 155 of grip segments extends an enlarged grip profile further along the handle than a second configuration 153 of grip segments. Second configuration 153 could be effectively converted to first configuration 155 removing the centermost reduced diameter grip segment and adding in an increased diameter grip segment adjacent to the central increased diameter grip segment.

Because the grip segments are individual pieces, each piece can move and flex independently of the others to create a suspension effect as a user's hand presses down onto the handlebar grip. Referring to FIG. 6, as a rotating force applied to a grip segment 150 increases from F1 to F2, the forgiving elasticity of the grip segment allows the grip segment 150 to flex slightly out of alignment with adjacent grip segments.

In the event a user wishes to change the configuration of an installed handle grip, the installation is at least partly reversed. The second clamp is loosened and slid from the compressible sleeve second end, one or more of two or more of the grip segments are removed from the compressible sleeve, the removed grip segments are replaced with one or more available grip segments and the second clamp is clamped on the compressible sleeve to lock the new arrangement of grip segments onto the handlebar.

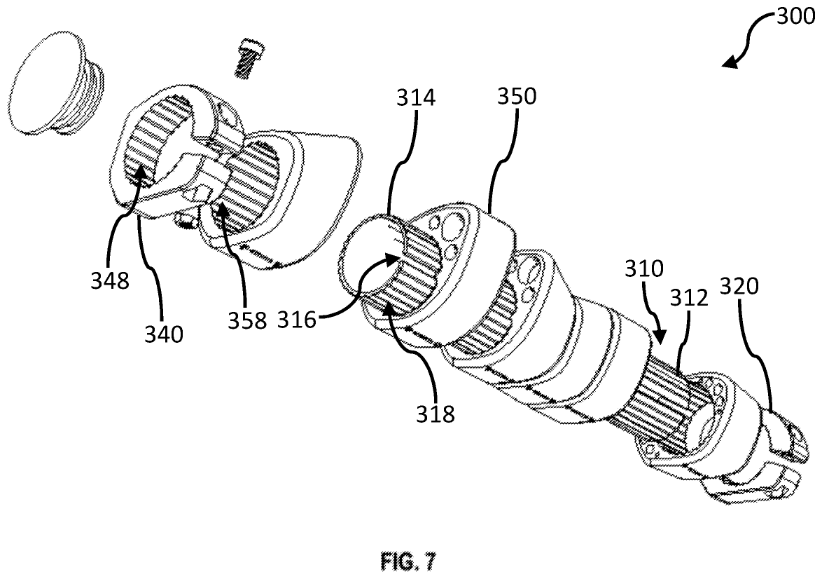

Referring to FIG. 7, in another embodiment 300 of handle grip system, a first slot 316 extends continuously and completely from first end 312 of compressible sleeve 310 to second end 314 of compressible sleeve 310 without any interruption. This form of slot may change the clamping dynamics of sleeve 310 around a handlebar as compared with sleeve 110. For example, less clamping force may be required to reduce slot 316 than is required for slot 116. Further, a clamping force applied to one end of compressible sleeve 310 may be transmitted along slot 316 to the other end which may be useful when clamping first collar 320 before second collar 340. As with system 100, collars 320 and 340 and grip segments 350 of system 300 include cooperative inner surfaces 348 and 358 for mating with cooperative outer surface 318.

Embodiments of the disclosure are susceptible to being used for various purposes, including, though not limited to, enabling users to provide a customized grip to an object such as a vehicle, sporting good or tool. In an example, a consumer orders disclosed handle grip systems through an online app that allows the consumer to design his/her custom grip before ordering so he/she gets the exact grip desired to fit his/her hand, style and/or vehicle.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

What is claimed is:

1. A handlebar grip system, comprising:
a clamping sleeve having a length between a first end and a second end and including a first slot extending between the first end and the second end and a plurality of elongate teeth spaced around a perimeter of the clamping sleeve and also extending between the first end and the second end thereof;
a first pipe clamp configured to surround the first end of the clamping sleeve and compress the clamping sleeve to reduce the first slot;
a second pipe clamp configured to surround the second end of the clamping sleeve and compress the clamping sleeve to reduce the first slot; and
a plurality of grip segments each having an interior opening configured to receive the clamping sleeve therethrough such that the elongate teeth mate with an inner wall of the interior opening.

2. A handle grip system, comprising:
a compressible sleeve having a length between a first end and a second end and a cooperative outer surface;
a first collar configured to surround the first end of the compressible sleeve and compress the compressible sleeve around a handlebar;
a second collar configured to surround the second end of the compressible sleeve and compress the compressible sleeve around the handlebar; and
a plurality of grip segments each having an interior opening configured to receive the compressible sleeve therethrough such that the cooperative outer surface couples with a cooperative inner surface of the interior opening.

3. The system as set forth in claim 2, wherein the cooperative outer surface of the compressible sleeve and the cooperative inner surface of the interior opening of the plurality of grip segments are configured to prevent relative rotation between any of the plurality of grip segments and the compressible sleeve.

4. The system as set forth in claim 2, wherein the cooperative outer surface of the compressible sleeve further comprises a plurality of splines.

5. The system as set forth in claim 2, wherein the plurality of grip segments further comprises grip segments of a plurality of cross-sectional shapes, a plurality of colors, a plurality of textures, a plurality of widths, a plurality of materials or a combination of these.

6. The system as set forth in claim 2, further comprising an end plug configured for receipt within one of the first and second collars and/or one of the first and second ends of the compressible sleeve.

7. The system as set forth in claim 2, wherein the first and second collars further comprise inner walls with the cooperative inner surface.

8. The system as set forth in claim 2, wherein each of the plurality of grip segments are configured to receive the compressible shaft at any of a variety of rotations about a longitudinal axis of the compressible shaft according to the cooperative outer surface and the cooperative inner surface.

9. The grip as set forth in claim 2, wherein the plurality of grip segments further comprises grip segments of a plurality of cross-sectional shapes, a plurality of colors, a plurality of textures, a plurality of widths, a plurality of materials or a combination of these.

10. The system as set forth in claim 2, wherein each of the plurality of grip segments has a width and the sum of the widths of the plurality of grip segments is greater than the length of the compressible sleeve.
The system as set forth in claim 4, wherein the sum of the widths of the plurality of grip segments is greater than the length of the compressible sleeve by a factor of at least two.

11. The system as set forth in claim 2, wherein each of a plurality of subsets of the plurality of grip segments yields a different grip profile.

12. The system as set forth in claim 2, wherein the compressible sleeve further comprises a first slot extending between the first end and the second end.

13. The system as set forth in claim 12, wherein the first and second collars are configured to reduce the first slot of the compressible sleeve.

14. A handlebar grip, comprising:
a clamping sleeve having a length between a first end and a second end and including a first slot extending between the first end and the second end and a plurality of ribs around a perimeter of the clamping sleeve and also extending between the first end and the second end thereof;
a first clamp surrounding the first end of the clamping sleeve and reducing the first slot to compress the clamping sleeve around a handlebar;
a second clamp surrounding the second end of the clamping sleeve and reducing the first slot to compress the clamping sleeve around a handlebar; and
a plurality of grip segments between the first clamp and the second clamp, wherein each of the plurality of grip segments has an interior opening receiving the clamping sleeve therethrough such that the ribs mate with an inner surface of the interior opening.

15. The grip as set forth in claim 14, wherein the inner surface of the plurality of grip segments further comprises a plurality of ribs.

16. The grip as set forth in claim 14, wherein each of the first and second clamps further comprise an inner surface in cooperation with the ribs of the clamping sleeve to prevent relative rotation between the first clamp, the second clamp and the clamping sleeve.

17. The grip as set forth in claim 14, wherein each of the first and second clamps further comprise an annular shape with a gap configured to be reduced by a bolt.

18. The grip as set forth in claim 14, wherein the first and second clamps hold the first slot in a reduced position.

19. The grip as set forth in claim 14, wherein the first slot extends continuously and completely from the first end of the clamping sleeve to the second end of the clamping sleeve.

20. The grip as set forth in claim 14, wherein the first slot is interrupted between the first end of the clamping sleeve and the second end of the clamping sleeve.
